(19) United States
(12) Patent Application Publication
(10) Pub. No.: US 2014/0195308 A1
(43) Pub. Date: Jul. 10, 2014

(54) ANALYZING THE CAPABILITIES OF A BUSINESS ENTERPRISE

(71) Applicant: INTERNATIONAL BUSINESS MACHINES CORPORATION, ARMONK, NY (US)

(72) Inventors: FRANCIS X. REDDINGTON, SARASOTA, FL (US); NEIL SAHOTA, COSTA MESA, CA (US)

(73) Assignee: INTERNATIONAL BUSINESS MACHINES CORPORATION, ARMONK, NY (US)

(21) Appl. No.: 13/737,537

(22) Filed: Jan. 9, 2013

(51) Int. Cl. G06Q 10/06

(52) U.S. Cl. CPC G06Q 10/0637
USPC 705/7.37; 705/7.36

(57) ABSTRACT

Analyzing the capabilities of a business enterprise, including: identifying, by a capability advisor module, capabilities required to carry out a business initiative; identifying, by the capability advisor module, capabilities of the business enterprise; and determining, by the capability advisor module, lacking capabilities of the business enterprise that are required to carry out the business initiative in dependence upon the capabilities required to carry out the business initiative and the capabilities of the business enterprise.

### BACKGROUND OF THE INVENTION

1. Field of the Invention

The field of the invention is data processing, or, more specifically, methods, apparatus, and products for analyzing the capabilities of a business enterprise.

2. Description of Related Art

When an organization attempts to accomplish a new business goal or initiative, it may fall short in achieving the full value. Even with strong ideas, organizations underscore their capability to achieve the business goal and realize the full business value. Organizations tend to focus on the actual solution aspects to produce a new system, product, business processes, or strategy. What they overlook is an assessment of their skill capabilities, maturity level as an organization, and fulfillment of the readiness factors to actually capture the full benefits of the initiative. This can happen when a business organization is trying to create something entirely new such as create a new system, product, business processes, or strategy. Consequently, with an incomplete understanding of the organizational and technical capabilities, teams experience difficulty in meeting the business benefit expectations, staying on-time and on-budget, and delivering a final product or service that users will adopt and use. Thus, even if the team does excellent work, the end results may be perceived as failures because the expected benefits were not fully realized.

### SUMMARY OF THE INVENTION

Methods, apparatus, and products for analyzing the capabilities of a business enterprise, including: identifying, by a capability advisor module, capabilities required to carry out a business initiative; identifying, by the capability advisor module, capabilities of the business enterprise; and determining, by the capability advisor module, lacking capabilities of the business enterprise that are required to carry out the business initiative in dependence upon the capabilities required to carry out the business initiative and the capabilities of the business enterprise.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computer useful in analyzing the capabilities of a business enterprise according to embodiments of the present invention.

FIG. 2 sets forth a flow chart illustrating an example method for analyzing the capabilities of a business enterprise according to embodiments of the present invention.

FIG. 3 sets forth a flow chart illustrating a further example method for analyzing the capabilities of a business enterprise according to embodiments of the present invention.

FIG. 4 sets forth a flow chart illustrating a further example method for analyzing the capabilities of a business enterprise according to embodiments of the present invention.

FIG. 5 sets for a block diagram illustrating the relationships between object definitions is a system for analyzing the capabilities of a business enterprise.

FIG. 6 sets forth a block diagram of an example decision tree for analyzing the capabilities of a business enterprise.

### DETAILED DESCRIPTION OF EXAMPLE EMBODIMENTS

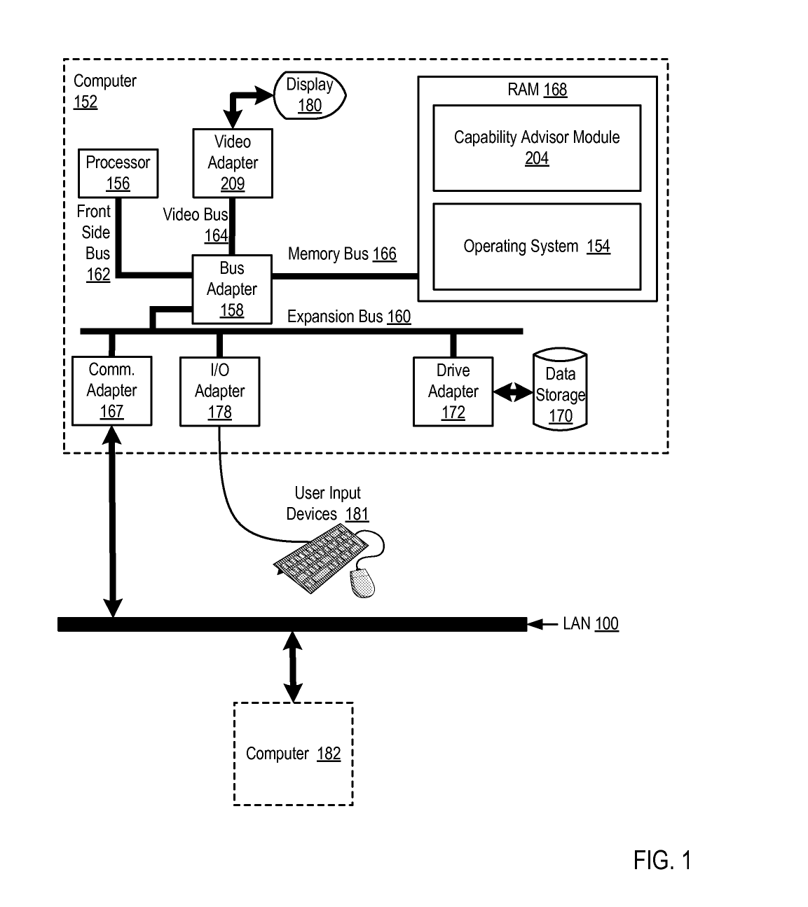

Example methods, apparatus, and products for analyzing the capabilities of a business enterprise in accordance with the present invention are described with reference to the accompanying drawings, beginning with FIG. 1. FIG. 1 sets forth a block diagram of automated computing machinery comprising an example computer (152) useful in analyzing the capabilities of a business enterprise according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a capability advisor module (204), a module of computer program instructions for analyzing the capabilities of a business enterprise according to embodiments of the present invention. A business enterprise may be embodied, for example, as a company or other business entity that engages in one or more business initiatives. Each business initiative represents a high level activity carried out by a business entity. For example, a business initiative may include producing a particular product, reducing the costs associated with engaging in some activity, attempting to meet a particular milestone, and so on.

The capability advisor module (204) of FIG. 1 can analyze the capabilities of a business enterprise by identifying capabilities required to carry out a business initiative. The capabilities required to carry out a business initiative represent the various resources and skillsets that are needed to carry out the business initiative. Consider an example in which the business enterprise desires to undertake a business initiative of manufacturing a particular device. In such an example, the capabilities required to carry out such a business initiative would include a manufacturing plant, manufacturing equipment, personnel to operate the manufacturing equipment, materials to be used in manufacturing the device, engineers to design the device, legal representatives to ensure that the device adheres to governmental regulations, and others as will occur to those of skill in the art.

The capability advisor module (204) of FIG. 1 can further analyze the capabilities of a business enterprise by identifying capabilities of the business enterprise. The capabilities of the business enterprise represent the various resources and skillsets that are possessed by the business enterprise. Examples of capabilities of the business enterprise can include physically resources owned by the business enterprise, financial resources held by the business enterprise, labor resources that are at the disposal of the business enterprise, and others as will occur to those of skill in the art. Identifying the capabilities of the business enterprise may be carried out, for example, by taking an inventory of assets available to the business enterprise.

The capability advisor module (204) of FIG. 1 can further analyze the capabilities of a business enterprise by determining the lacking capabilities of the business enterprise that are required to carry out the business initiative. Determining the lacking capabilities of the business enterprise that are required to carry out the business initiative is carried out in dependence upon the capabilities required to carry out the business initiative and the capabilities of the business enterprise. Determining the lacking capabilities of the business enterprise that are required to carry out the business initiative may be carried out by identifying those capabilities that required to carry out the business initiative which are not included in the set of capabilities of the business enterprise.

Consider the example described above in which the business enterprise desires to undertake a business initiative of manufacturing a particular device. Assume that the capabilities required to carry out such a business initiative include a manufacturing plant, manufacturing equipment, personnel to operate the manufacturing equipment, materials to be used in manufacturing the device, engineers to design the device, and legal representatives to ensure that the device adheres to governmental regulations. In such example, assume that the capability advisor module has determined that the business enterprise includes the capabilities of a manufacturing plant, manufacturing equipment, personnel to operate the manufacturing equipment, materials to be used in manufacturing the device, and legal representatives to ensure that the device adheres to governmental regulations. In such an example, however, engineers to design the device are not part of the set of capabilities of the business enterprise. As such, engineers to design the device would be identified as a lacking capability of the business enterprise. In such an example, the lacking capabilities of the business enterprise can be reported to operatives of the business enterprise for consideration when determining whether to move forward with the business initiative.

Also stored in RAM (168) is an operating system (154). Operating systems useful is analyzing the capabilities of a business enterprise according to embodiments of the present invention include UNIX™, Linux™, Microsoft XP™, AIX™, IBM's i5/OS™, and others as will occur to those of skill in the art. The operating system (154) and the capability advisor module (204) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for analyzing the capabilities of a business enterprise according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for analyzing the capabilities of a business enterprise according to embodiments of the present invention include modems for wired dial-up communications, Ethernet (IEEE 802.3) adapters for wired data communications network communications, and 802.11 adapters for wireless data communications network communications.

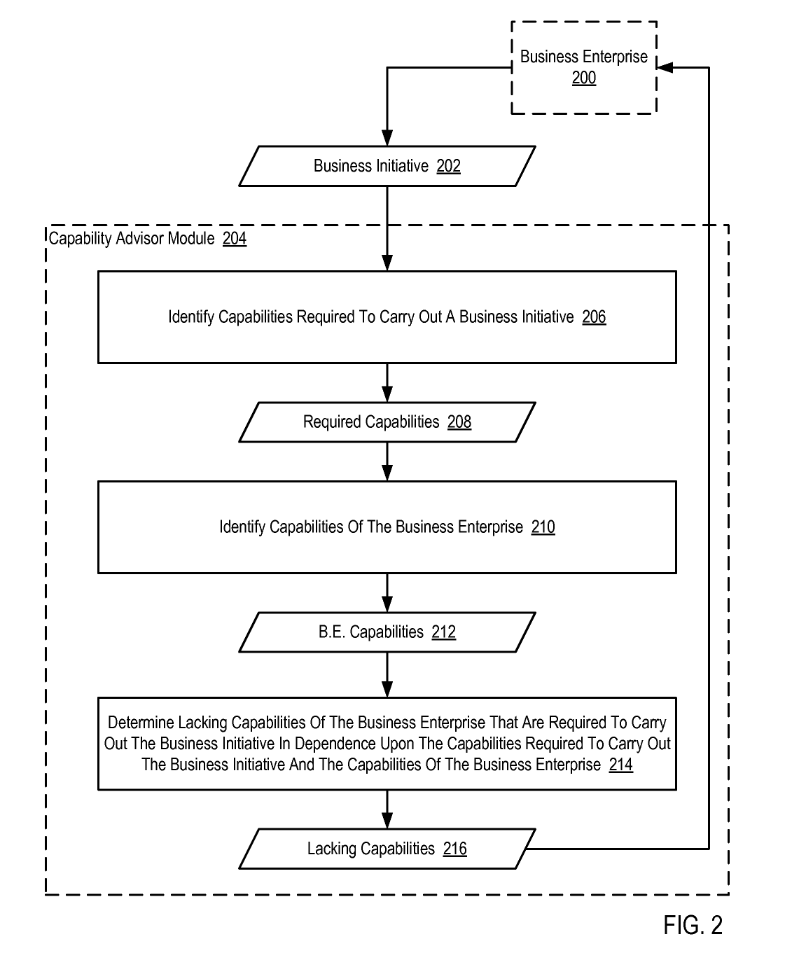

For further explanation, FIG. 2 sets forth a flow chart illustrating an example method for analyzing the capabilities of a business enterprise (200) according to embodiments of the present invention. A business enterprise may be embodied, for example, as a company or other business entity that engages in one or more business initiatives. Each business initiative represents a high level activity carried out by a business entity. For example, a business initiative may include producing a particular product, reducing the costs associated with engaging in some activity, attempting to meet a particular milestone, and so on. Each business enterprise (200) illustrated in FIG. 2 represents an abstraction of an actual business and each business initiative (202) represents an abstraction of an activity carried out by the actual business.

The example method of FIG. 2 is carried out by a capability advisor module (204). The capability advisor module (204) of FIG. 2 may be embodied, for example, as a module of computer program instructions executing on computer hardware such as a computer processor. In the example method of FIG. 2, the capability advisor module (204) is illustrated as being external to a business enterprise (200). Readers will appreciate that the capability advisor module (204) may also be one of the resources that are part of the business enterprise (200). For example, a particular business enterprise (200) may own one or more servers that are executing the capability advisor module (204).

The example method of FIG. 2 includes identifying (206), by a capability advisor module (204), capabilities (208) required to carry out a business initiative (202). In the example method of FIG. 2, the capabilities (208) required to carry out a business initiative (202) represent the various resources and skillsets that are needed to carry out the business initiative (202). Consider an example in which the business enterprise (200) desires to undertake a business initiative (202) of manufacturing a particular device. In such an example, the capabilities (208) required to carry out such a business initiative (202) would include a manufacturing plant, manufacturing equipment, personnel to operate the manufacturing equipment, materials to be used in manufacturing the device, engineers to design the device, legal representatives to ensure that the device adheres to governmental regulations, and others as will occur to those of skill in the art.

In the example method of FIG. 2, the capabilities (208) required to carry out a business initiative (202) may be identified by the business initiative (202) itself. For example, the business initiative (202) may be embodied as a data structure that includes identifiers for one or more capabilities (208) that are required to carry out the business initiative (202). Alternatively, the capabilities (208) required to carry out a business initiative (202) may be identified through the use of a central data repository that includes information identifying the capabilities (208) required to carry out various common business initiatives (202). Such a repository may be developed over time as an entry can be created for each business initiative (202) encountered by the capability advisor module (204). The entry that is created for each business initiative (202) encountered by the capability advisor module (204) can also include information identifying the capabilities (208) that were required to carry out the business initiative (202) identified in a particular entry.

The example method of FIG. 2 also includes identifying (210), by the capability advisor module (204), capabilities (212) of the business enterprise (200). In the example method of FIG. 2 the capabilities (212) of the business enterprise (200) represent the various resources and skillsets that are possessed by the business enterprise (200). Examples of capabilities (212) of the business enterprise (200) can include, for example, physically resources owned by the business enterprise (200), financial resources held by the business enterprise (200), labor resources that are at the disposal of the business enterprise (200), and others as will occur to those of skill in the art.

In the example method of FIG. 2, identifying (210) the capabilities (212) of the business enterprise (200) may be carried out, for example, by taking an inventory of assets available to the business enterprise (200). The capability advisor module (200) can learn of the inventory of assets available to the business enterprise (200), for example, through the use of a graphical user interface that allows a user to identify all assets available to the business enterprise (200). Each asset available to the business enterprise (200) can be categorized into one or more common asset category such that the capabilities provided by each asset can be understood.

The example method of FIG. 2 also includes determining (214), by the capability advisor module (204), lacking capabilities (216) of the business enterprise (200) that are required to carry out the business initiative (202). Determining (214) the lacking capabilities (216) of the business enterprise (200) that are required to carry out the business initiative (202) is carried out in dependence upon the capabilities (208) required to carry out the business initiative (202) and the capabilities (212) of the business enterprise (200). In the example method of FIG. 2, determining (214) the lacking capabilities (216) of the business enterprise (200) that are required to carry out the business initiative (202) may be carried out by identifying those capabilities (208) that required to carry out the business initiative (202) which are not included in the set of capabilities (212) of the business enterprise (200).

Consider the example described above in which the business enterprise (200) desires to undertake a business initiative (202) of manufacturing a particular device. Assume that the capabilities (208) required to carry out such a business initiative (202) include a manufacturing plant, manufacturing equipment, personnel to operate the manufacturing equipment, materials to be used in manufacturing the device, engineers to design the device, and legal representatives to ensure that the device adheres to governmental regulations. In such example, assume that the capability advisor module (204) has determined that the business enterprise (200) includes the capabilities of a manufacturing plant, manufacturing equipment, personnel to operate the manufacturing equipment, materials to be used in manufacturing the device, and legal representatives to ensure that the device adheres to governmental regulations. In such an example, however, engineers to design the device are not part of the set of capabilities of the business enterprise (200). As such, engineers to design the device would be identified as a lacking capability (216) of the business enterprise (200). In such an example, the lacking capabilities (216) of the business enterprise (200) can be reported to operatives of the business enterprise (200) for consideration when determining whether to move forward with the business initiative (202).

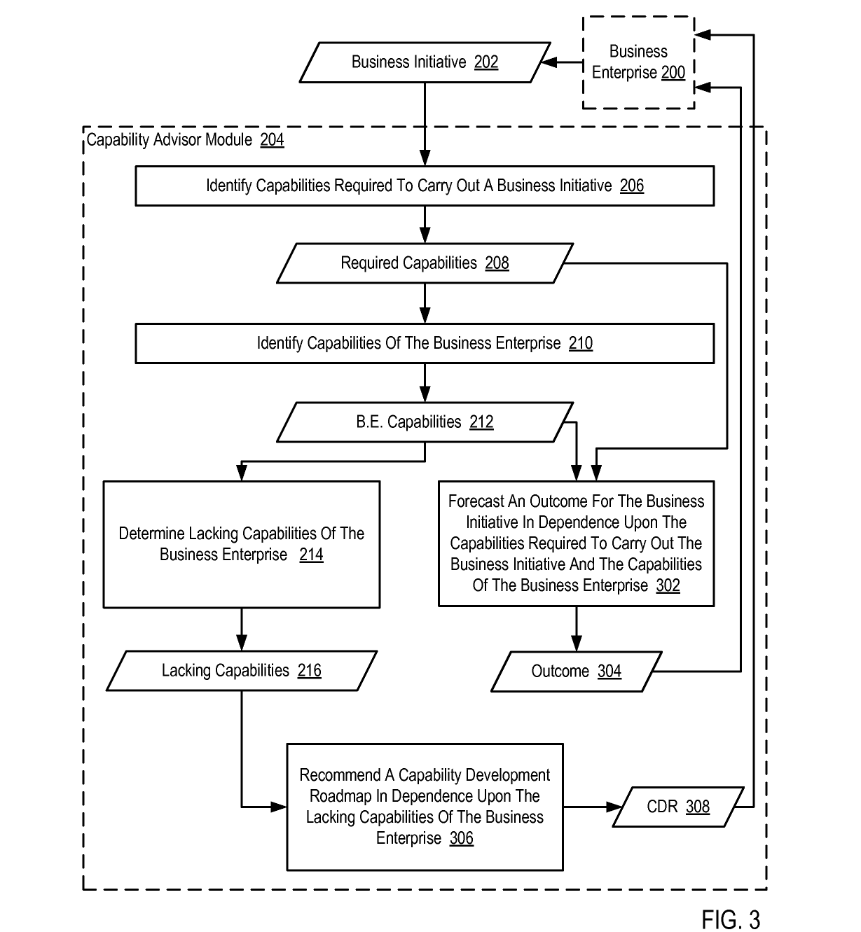

For further explanation, FIG. 3 sets forth a flow chart illustrating a further example method for analyzing the capabilities of a business enterprise (200) according to embodiments of the present invention. The example method of FIG. 3 is similar to the example method of FIG. 2 as it also includes identifying (206) capabilities (208) required to carry out a business initiative (202), identifying (210) capabilities (212) of the business enterprise (200), and determining (214) lacking capabilities (216) of the business enterprise (200).

The example method of FIG. 3 also includes forecasting (302), by the capability advisor module (204), an outcome (304) for the business initiative (202) in dependence upon the capabilities (208) required to carry out the business initiative (202) and the capabilities (212) of the business enterprise (200). In the example method of FIG. 3, the outcome (304) for the business initiative (202) can include information describing the result of attempting to carry out the business initiative (202) given the current set of capabilities (212) possessed by the business enterprise (200). In the example method of FIG. 3, the outcome (304) for the business initiative (202) can include information such as, for example, the amount of time required to carry out the business initiative (202), the amount of expenses that will be encountered to carry out the business initiative (202), the cost associated with developing capabilities that are needed to carry out the business initiative (200), a predicted likelihood of success in actually carrying out the business initiative (200), and others as will occur to those of skill in the art.

In the example method of FIG. 3, forecasting (302) the outcome (304) for the business initiative (202) may be carried out, for example, by identifying the lacking capabilities (216) of the business enterprise (200) in dependence upon the capabilities (208) required to carry out the business initiative (202) and the capabilities (212) of the business enterprise (200) and determining the costs associated with acquiring the lacking capabilities (216). The costs associated with a particular lacking capability (216) may be determined, for example, through the use of a central data repository that includes information describing the cost of common capabilities. The central data repository may specify the cost of common capabilities in terms of time, man hours, dollars, and so on.

The example method of FIG. 3 also includes recommending (306), by the capability advisor module (204), a capability development roadmap (308) in dependence upon the lacking capabilities (216) of the business enterprise (200). In the example method of FIG. 3, the capability development roadmap (308) represents information describing various aspects of acquiring one or more capabilities. The capability development roadmap (308) can include, for example, information identifying the cost associated with acquiring one or more capabilities, the amount of time required to develop one or more capabilities, a prioritization of the order in which the one or more capabilities should be developed, information identifying interdependencies between various capabilities, and so on.

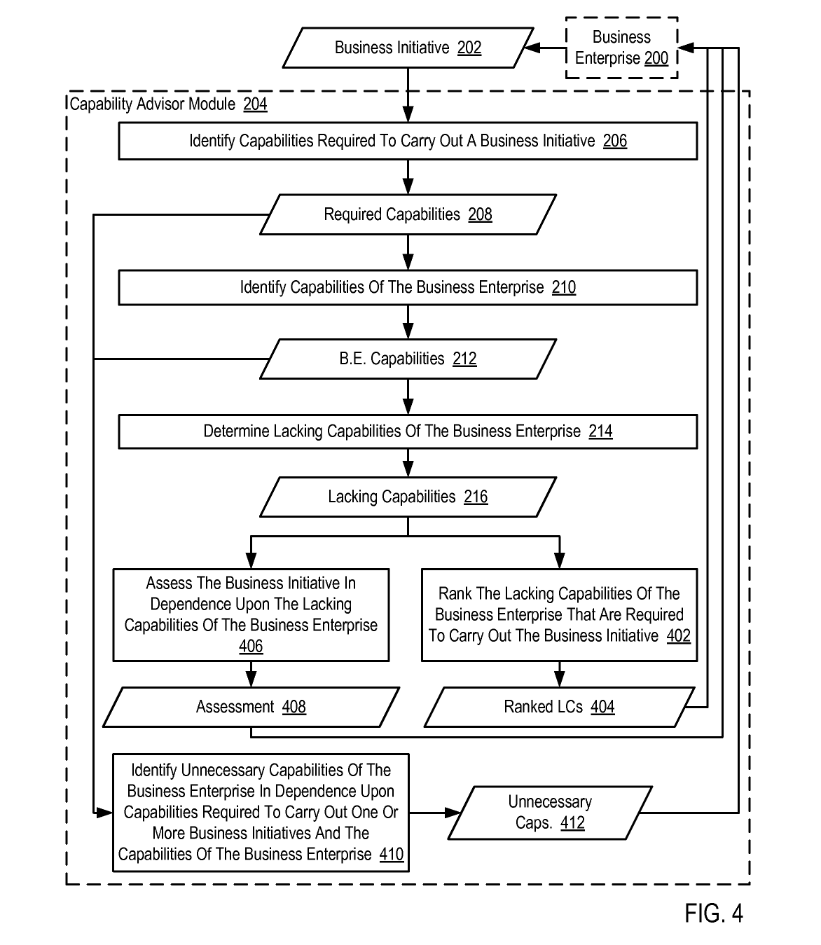

For further explanation, FIG. 4 sets forth a flow chart illustrating a further example method for analyzing the capabilities of a business enterprise (200) according to embodiments of the present invention. The example method of FIG. 4 is similar to the example method of FIG. 2 as it also includes identifying (206) capabilities (208) required to carry out a business initiative (202), identifying (210) capabilities (212) of the business enterprise (200), and determining (214) lacking capabilities (216) of the business enterprise (200).

The example method of FIG. 4 also includes identifying (410), by the capability advisor module (204), unnecessary capabilities (412) of the business enterprise (200) in dependence upon the capabilities (208) required to carry out one or more business initiatives (202) and the capabilities (212) of the business enterprise (200). In the example method of FIG. 4, the unnecessary capabilities (412) of the business enterprise (200) represent capabilities (212) of the business enterprise (200) that are not used to carry out any business initiative (202) of the business enterprise (200). In the example method of FIG. 4, identifying (410) unnecessary capabilities (412) may be carried out by identifying the capabilities (212) of the business enterprise (200) that are not included in the set of capabilities (208) required to carry all of the business initiatives (202) that the business enterprise (200) is engaged in. By identifying (410) unnecessary capabilities (412), the business enterprise (200) may rededicate resources that are associated with the unnecessary capabilities (412) to develop lacking capabilities (216) that are required to carry out one or more business initiatives (202).

The example method of FIG. 4 also includes ranking (402), by the capability advisor module (204), the lacking capabilities (216) of the business enterprise (200) that are required to carry out the business initiative (202). In the example method of FIG. 4, the lacking capabilities (216) of the business enterprise (200) that are required to carry out the business initiative (202) may be ranked (402) such that the most important lacking capabilities (216) are developed first. The lacking capabilities (216) may be ranked, for example, by virtue of the cost associated to develop the lacking capabilities (216), the amount of time required to develop the lacking capabilities (216), and so on. The ranked lacking capabilities (404) may be provided to operatives within the business enterprise (200) for consideration when developing the lacking capabilities (216).

The example method of FIG. 4 also includes assessing (406), by the capability advisor module (204), the business initiative (200) in dependence upon the lacking capabilities (216) of the business enterprise (200). In the example method of FIG. 4, assessing (406) the business initiative (200) in dependence upon the lacking capabilities (216) of the business enterprise (200) may be carried out by calculating the total amount of expense and time that will be required to carry out the business initiative (200), including the amount of expense and time that will be required to develop lacking capabilities (216), and comparing the result of such a calculation to the expected benefit of carrying out the business initiative (200) to ensure that undertaking to perform the business initiative (200) is worthwhile. In the example method of FIG. 4, the assessment (408) of the business initiative (200) may identify expected expenses associated with carrying out the business initiative (202), expected profits associated with carrying out the business initiative (202), the impact on other business initiatives that will result from dedicating resources to carrying out the business initiative (202), a general determination as to whether carrying out the business initiative (202) is worthwhile, and so on.

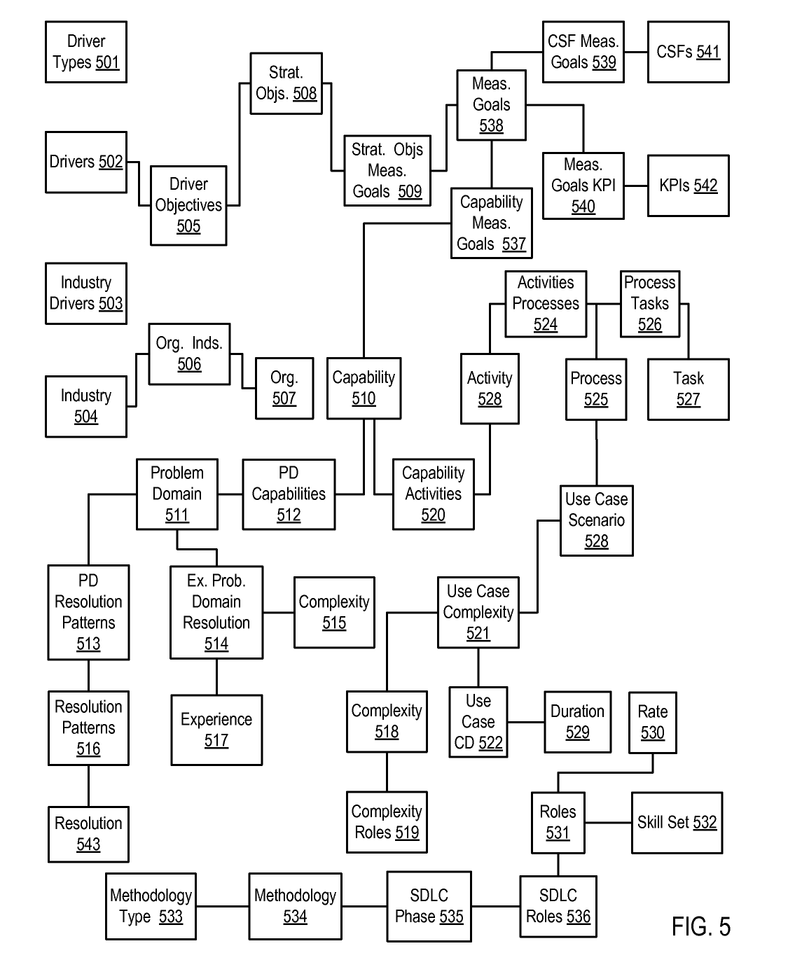

For further explanation, FIG. 5 sets for a block diagram illustrating the relationships between object definitions is a system for analyzing the capabilities of a business enterprise. Each object represents a data structure in such a system, and may be related to other objects as illustrated in FIG. 5. The definition of each object may be described in a table such as Table 1:

TABLE 1
Object Definition Table

| Object Name | Definition |
|---|---|
| Driver Types (501) | Type of motivating influencers |
| Drivers (502) | Motivating influencer that trigger |
| | strategic planning |
| Industry Drivers (503) | Industry influencers |
| Industries (504) | Business domain |
| Driver Objectives (505) | Objective derived from motivating |
| | influencers |
| Organization Industries (506) | Firms line of business |
| Organization (507) | A Firm |
| Strategic Objectives (508) | Objects required to be achieved in |
| | order to execute planned strategy |
| Strategic Objectives Measurable | Achievements related to a particular |
| Goals (509) | strategic objective that are |
| | measurable |
| Capability (510) | The ability to perform actions or |
| | activities |
| Problem Domain (511) | Area of expertise |
| Problem Domain Capabilities (512) | Known capabilities with a certain |
| | problem domains |
| Problem Domain Resolution | Repeatable set of solution activities |
| Patterns (513) | within a problem domain |
| Experience Problem Domain | Length of successful problem |
| Resolution (514) | domain resolution |
| Competency (515) | The ability to handle certain |
| | situations properly |
| Resolution Patterns (516) | Known remedies |
| Experience (517) | Time of exposure |
| Complexity (518) | Is the relative level of difficulty |
| Complexity Roles (519) | Are the required Roles with the |
| | associated Skill Set to execute the |
| | use case properly |
| Capability Activities (520) | Activities associated to a capability |
| Use Case Complexity (521) | The level of effort to perform the |
| | Use Case |
| Use Case Complexity | The length of time the Use Case is |
| Duration (522) | complex |
| Activities (523) | Consist on one or more processes |
| Activities Processes (524) | Processes defined within an activity |
| Process (525) | Contain one of more tasks |
| Process Tasks (526) | Tasks within a process |
| Tasks (527) | Single unit of work within a process |
| Use Case Scenario (528) | The realization of process by a user |
| Duration (529) | The length of time |
| Rate (530) | Charge factor |
| Roles (531) | Defined position of responsibilities |
| Skill Set (532) | Trained abilities |
| Methodology Type (533) | Type of approach adopted |
| Methodology (534) | Approach adopted |
| SDLC Phase (535) | Phases within a system development |
| | lifecycle |
| SDLC Roles (536) | Roles defined within a system |
| | development lifecycle |
| Capability Measurable Goals (537) | Measurable goal achieved through |
| | capability |
| Measurable Goals (538) | Achievements that are measurable |
| Critical Success Factor (CSF) | Measurable goals associated to |
| Measurable Goals (539) | critical success factors |
| Measurable Goal KPI (540) | Performance indicator how close |
| | you are to attaining a measurable |
| | goal |
| Critical Success Factors (541) | Significant factor required for the |
| | success achievement of strategic |
| | objectives |
| KPI (542) | Key Performance Indicator |
| Resolution (543) | Resolved remedy of known problem |

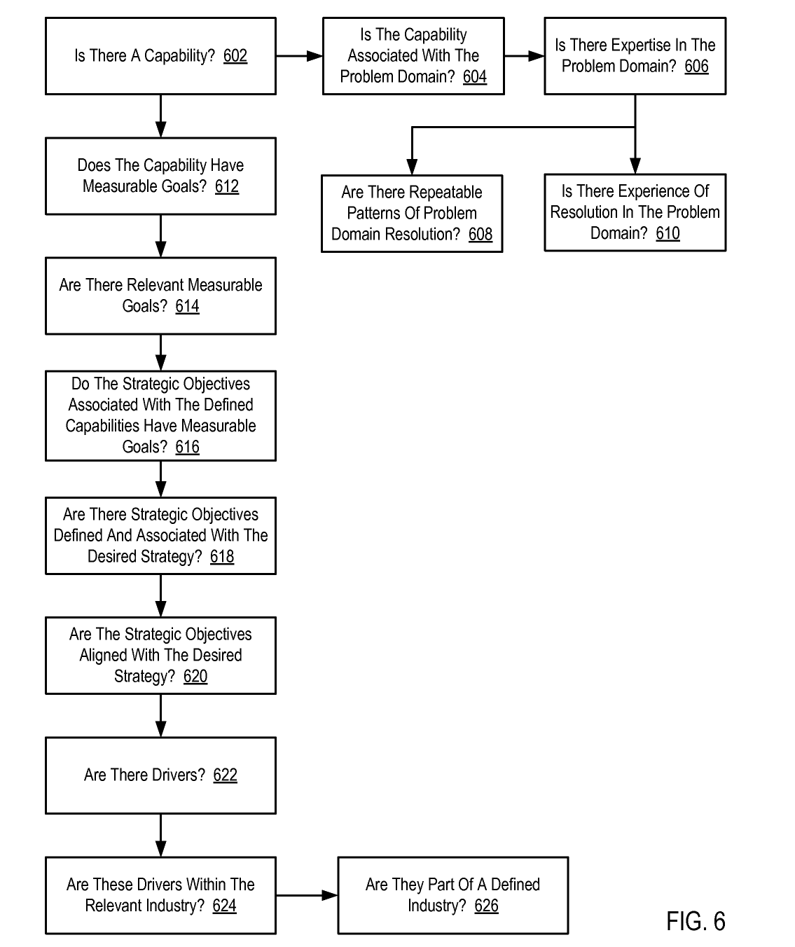

For further explanation, FIG. 6 sets forth a block diagram of an example decision tree for analyzing the capabilities of a business enterprise. In the decision tree of FIG. 6 includes the question of “is there a capability?” (602) In response to determining that there is a capability, another question may be “is the capability associated with the problem domain?” (604) In response to determining that the capability is associated with the relevant problem domain, another question may be “is there expertise in the problem domain?” (606) In response to determining that there is expertise in the problem domain, another question may “are there repeatable patterns of problem domain resolution?” (608) In further response to determining that there is expertise in the problem domain, another question may be “is there experience of resolution in the problem domain?” (610)

In further response to determining that there is a capability, another question may be “does the capability have measurable goals?” (612) In response to determining that the capability has measurable goals, another question may be “are there relevant measurable goals?” (614) In response to determining that the measurable goals are relevant, another question may be “do the strategic objectives associated with the defined capabilities have measurable goals?” (616) In response to determining that the strategic objectives associated with the defined capabilities have measurable goals, another question may be “are there strategic objectives defined and associated with the desired strategy?” (618) In response to determining that there are strategic objectives defined and associated with the desired strategy, another question may be “are there strategic objectives aligned with the desired strategy?” (620) In response to determining that the strategic objectives are aligned with the desired strategy, another question may be “are there drivers?” (622) In response to determining that there are drivers, another question may be “are these drivers within the relevant industry?” (624) In response to determining that the drivers are within the relevant industry, another question may be “are they part of a defined industry?” (626). In the example of FIG. 6, by answering each question in the example decision tree, a business entity may be better equipped to determine whether there current capabilities will allow that business entity to accomplish various objectives.

Example embodiments of the present invention are described largely in the context of a fully functional computer system for analyzing the capabilities of a business enterprise. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method of analyzing the capabilities of a business enterprise, the method comprising:
identifying, by a capability advisor module, capabilities required to carry out a business initiative;
identifying, by the capability advisor module, capabilities of the business enterprise; and
determining, by the capability advisor module, lacking capabilities of the business enterprise that are required to carry out the business initiative in dependence upon the capabilities required to carry out the business initiative and the capabilities of the business enterprise.

2. The method of claim 1 further comprising forecasting, by the capability advisor module, an outcome for the business initiative in dependence upon the capabilities required to carry out the business initiative and the capabilities of the business enterprise.

3. The method of claim 1 further comprising recommending, by the capability advisor module, a capability development roadmap in dependence upon the lacking capabilities of the business enterprise.

4. The method of claim 1 further comprising identifying, by the capability advisor module, unnecessary capabilities of the business enterprise in dependence upon the capabilities required to carry out one or more business initiatives and the capabilities of the business enterprise.

5. The method of claim 1 further comprising ranking, by the capability advisor module, the lacking capabilities of the business enterprise that are required to carry out the business initiative.

6. The method of claim 1 further comprising assessing, by the capability advisor module, the business initiative in dependence upon the lacking capabilities of the business enterprise.

7. An apparatus for analyzing the capabilities of a business enterprise, the apparatus comprising a computer processor, a computer memory operatively coupled to the computer processor, the computer memory having disposed within it computer program instructions that, when executed by the computer processor, cause the apparatus to carry out the steps of:
identifying, by a capability advisor module, capabilities required to carry out a business initiative;
identifying, by the capability advisor module, capabilities of the business enterprise; and
determining, by the capability advisor module, lacking capabilities of the business enterprise that are required to carry out the business initiative in dependence upon the capabilities required to carry out the business initiative and the capabilities of the business enterprise.

8. The apparatus of claim 7 further comprising computer program instructions that, when executed by the computer processor, cause the apparatus to carry out the step of forecasting, by the capability advisor module, an outcome for the business initiative in dependence upon the capabilities required to carry out the business initiative and the capabilities of the business enterprise.

9. The apparatus of claim 7 further comprising computer program instructions that, when executed by the computer processor, cause the apparatus to carry out the step of recommending, by the capability advisor module, a capability development roadmap in dependence upon the lacking capabilities of the business enterprise.

10. The apparatus of claim 7 further comprising computer program instructions that, when executed by the computer processor, cause the apparatus to carry out the step of identifying, by the capability advisor module, unnecessary capabilities of the business enterprise in dependence upon the capabilities required to carry out one or more business initiatives and the capabilities of the business enterprise.

11. The apparatus of claim 7 further comprising computer program instructions that, when executed by the computer processor, cause the apparatus to carry out the step of ranking, by the capability advisor module, the lacking capabilities of the business enterprise that are required to carry out the business initiative.

12. The apparatus of claim 7 further comprising computer program instructions that, when executed by the computer processor, cause the apparatus to carry out the step of assessing, by the capability advisor module, the business initiative in dependence upon the lacking capabilities of the business enterprise.

13. A computer program product for analyzing the capabilities of a business enterprise, the computer program product disposed upon a computer readable medium, the computer program product comprising computer program instructions that, when executed, cause a computer to carry out the steps of:
identifying, by a capability advisor module, capabilities required to carry out a business initiative;
identifying, by the capability advisor module, capabilities of the business enterprise; and
determining, by the capability advisor module, lacking capabilities of the business enterprise that are required to carry out the business initiative in dependence upon the capabilities required to carry out the business initiative and the capabilities of the business enterprise.

14. The computer program product of claim 13 further comprising computer program instructions that, when executed, cause the computer to carry out the step of forecasting, by the capability advisor module, an outcome for the business initiative in dependence upon the capabilities required to carry out the business initiative and the capabilities of the business enterprise.

15. The computer program product of claim 13 further comprising computer program instructions that, when executed, cause the computer to carry out the step of recommending, by the capability advisor module, a capability development roadmap in dependence upon the lacking capabilities of the business enterprise.

16. The computer program product of claim 13 further comprising computer program instructions that, when executed, cause the computer to carry out the step of identifying, by the capability advisor module, unnecessary capabilities of the business enterprise in dependence upon the capabilities required to carry out one or more business initiatives and the capabilities of the business enterprise.

17. The computer program product of claim 13 further comprising computer program instructions that, when executed, cause the computer to carry out the step of ranking, by the capability advisor module, the lacking capabilities of the business enterprise that are required to carry out the business initiative.

18. The computer program product of claim 13 further comprising computer program instructions that, when executed, cause the computer to carry out the step of assessing, by the capability advisor module, the business initiative in dependence upon the lacking capabilities of the business enterprise.

19. The computer program product of claim 13 wherein the computer readable medium comprises a signal medium.

20. The computer program product of claim 13 wherein the computer readable medium comprises a storage medium.
